(19) United States
(12) Patent Application Publication
(10) Pub. No.: US 2013/0139978 A1
(43) Pub. Date: Jun. 6, 2013

(54) ADJUSTABLE STRIP DOOR, STRIP DOOR KIT, AND METHOD FOR MAKING THE SAME

(71) Applicant: Dennis Richard McKinnon, Upland, CA (US)

(72) Inventor: Dennis Richard McKinnon, Upland, CA (US)

(73) Assignee: TRIO DISTRIBUTORS, INC., Upland, CA (US)

(21) Appl. No.: 13/312,727

(22) Filed: Dec. 6, 2011

(51) Int. Cl. E06B 9/00; B23P 11/00

(52) U.S. Cl. 160/182; 29/428

(57) ABSTRACT

At least one feature provides a strip door that includes a bracket adapted to secure to a first support surface associated with an opening, where the bracket includes a plurality of mount holes spaced along a length of the bracket. The strip door further includes a plurality of strip mounts wherein each strip mount is adapted to couple to at least one of the plurality of mount holes, where the plurality of strip mounts are adapted to be arranged along the length of the bracket. Moreover, the strip door may further include a plurality of strips adapted to hang in a partially overlapping arrangement to form a barrier to the opening, where each strip comprises a first end and a second end, and wherein the first end of each strip is adapted to removeably couple to an independent strip mount of the plurality of strip mounts.

### BACKGROUND

1. Field

Various embodiments of the disclosure pertain generally to strip doors strip doors wherein a plurality of strips are hung in an overlapping arrangement in a doorway to provide an insulating barrier that is easy to walk through. Specifically, the disclosure relates to adjustable strip doors, strip door kits, and methods for making the same.

2. Background

A conventional door may not be satisfactory for retaining heat or cold within a room where people and/or goods frequently passing through the doorway make it impractical to keep opening and closing the conventional door. For example, a cold storage room is often equipped with a heavily, insulated door which may be satisfactory when the room is closed. However, during times of heavy traffic through the doorway it may not be practical to continue to open and close the door. As such, some users of the doorway may simply leave the door open resulting in a considerable loss of energy due to hotter ambient air flowing into the room.

Strip doors, which offer a solution to the aforementioned problem, have become increasingly important because of an emphasis in recent years for energy conservation. Strip doors are often made of a plurality of heavy, transparent plastic strips that hang in an overlapping arrangement in a doorway to provide an effective thermal, see-through barrier. For example, strip doors are effective in minimizing cold loss from a cold storage room or preventing heat loss from an interior room to a colder exterior when the outside air is cold.

FIG. 1 illustrates a plastic strip door 100 found in the prior art. A plurality of strips 110 are suspended from above a cold storage room's doorway 112. The conventional hinged doors 114 of the cold storage room's doorway 112 have been folded back out of the way to permit the passage of cargo 116. Each strip overlaps the edge of an adjacent strip to provide a thermal barrier between the inside of the cold storage room and the ambient air outside. Although the strips 110 may be made of a relatively heavy plastic material, the strips 110 are easily parted as shown in the illustrated example by the person moving a stack of cargo 116 through the doorway 112. After the person passes, the strips 110 will quickly return to their normal vertically hanging position. Thus, the strip door 100 is only momentarily open so that heat transfer through the door is minimized. The plastic strips 110 are typically made of a transparent or translucent material so that a person can pass through the door with confidence by being able to see whether there is any obstruction on the other side. Thus, the illustrated strip door 100 helps serve as an insulating barrier at the cold storage room's doorway 112.

The systems and methods used in the prior art to assemble strip doors and support the plastic strips may have significant disadvantages. Some strip doors in the prior art are assembled by first placing the strips on a horizontal surface in the desired overlapping arrangement. Then, the upper ends of the strips are clamped between two metal mounting bars that are subsequently held in the clamped position by a plurality of bolts or other fasteners. The entire assembly is then lifted and attached to a wall with additional fasteners. Assembling a strip door in such a fashion typically requires two people and considerable time. Moreover, if a strip should later become worn or damaged, the entire strip door may have to be removed in order to replace a single strip. The individual strips of such a strip door may also endure a relatively large amount of stress at the point where they are clamped to the metal mounting bars when the strips are pushed open. This stress over time results in an increased risk of the strip tearing and strip wear. Moreover, prior art strip doors provide limited means for adjusting the position and orientation of the strips relative to the doorway and each other.

Thus, there is a need for a strip door, strip door kit, and methods for making the same that: provide adjustability of the orientation and positioning of the strips; offer a way to quickly and easily replace individual strips; extend the lifespan of the strips by reducing the amount of stress experienced by the strips; offer less resistance to a user and/or cargo passing though the strip door; maximize insulation of the room the strip door serves a barrier for; and other improvements over prior art strip door designs.

### SUMMARY

One feature provides a strip door that comprises a bracket adapted to secure to a first support surface associated with an opening, the bracket including a plurality of mount holes spaced along a length of the bracket. The strip door further comprises a plurality of strip mounts wherein each strip mount is adapted to couple to at least one of the plurality of mount holes, the plurality of strip mounts adapted to be arranged along the length of the bracket. The strip door further comprises a plurality of strips adapted to hang in a partially overlapping arrangement to form a barrier to the opening, each strip including a first end and a second end, wherein the first end of each strip is adapted to removeably couple to an independent strip mount of the plurality of strip mounts. The first end of each strip may comprise a loop adapted to removably couple the strip to the independent strip mount. Moreover, each strip mount may comprise a first end, a second end, and at least one strip mount fastener positioned between the first end and the second end of the strip mount, the strip mount fastener adapted to removeably couple the strip mount to at least one of the mount holes of the bracket. In one embodiment, the first end of each strip comprises a first loop and a second loop, wherein the first loop of the strip is adapted to removeably couple to the first end of the strip mount, and the second loop of the strip is adapted to removeably couple to the second end of the strip mount. The first end and the second end of the strip mount may comprise a curved surface.

In one embodiment, each strip mount comprises a first strip mount fastener positioned at a first end of the strip mount, the first strip mount fastener adapted to removeably couple the first end of the strip mount to a first mount hole of the plurality of mount holes of the bracket, and a second strip mount fastener positioned at a second end of the strip mount, the second strip mount fastener adapted to removeably couple the second end of the strip mount to a second mount hole of the plurality of mount holes of the bracket, wherein the first end of each strip comprises a loop adapted to removably couple to a region of the strip mount in between the first strip mount fastener and the second strip mount fastener of the strip mount. In another embodiment, the strip door further comprises a sealing strip adapted to secure, at least partially, between the first support surface and the bracket, wherein a length of the sealing strip is positioned parallel relative to the length of the bracket. The plurality of mount holes spaced along the length of the bracket may be positioned on a first surface of the bracket. In one embodiment, the bracket further comprises a second surface including a plurality of support holes, the second surface of the bracket positioned at an angle between sixty (60) and one hundred twenty (120) degrees relative to the first surface of the bracket, wherein the sealing strip is secured to at least one of the support holes via a sealing strip fastener.

In one embodiment, a length of each strip mount of the plurality of strip mounts is parallel to a length of an adjacent strip mount. In another embodiment, a length of each strip mount of the plurality of strip mounts is positioned at an angle relative to a length of an adjacent strip mount. In yet another embodiment, at least one strip mount of the plurality of strip mounts is positioned at an angle relative to the length of the bracket. As one example, the angle may be between five (5) and thirty-five (35) degrees. In one embodiment, the mount holes are elongated holes that are adapted to secure a length of each strip mount at an angle relative to the length of the bracket. In another embodiment, the strip mounts are adapted to removeably couple to the mount holes to adjust a spacing between the strip mounts, the spacing between the strip mounts determining an amount of strip overlap of the plurality of strips. In yet another embodiment, a first strip of the plurality of strips is coupled to a first strip mount of the plurality of strip mounts, and a length of the first strip mount is positioned at an angle relative to the length of the bracket such that a first edge of the first strip is adapted to contact a second support surface associated with the opening. Moreover, a second strip of the plurality of strips may be coupled to a second strip mount of the plurality of strip mounts, and a length of the second strip mount may be positioned at an angle relative to the length of the bracket such that a first edge of the second strip is adapted to contact a third support surface associated with the opening.

Another feature provides a strip door that comprises a means for securing the strip door to a first support surface associated with an opening, the means for securing including a plurality of mount holes spaced along a length of the means for securing. The strip door further comprises a plurality of means for coupling a plurality of strips to the means for securing, where the plurality of strips are adapted to hang in a partially overlapping arrangement to form a barrier to the opening. Each strip may include a first end and a second end, wherein the first end of each strip is adapted to removeably couple to an independent means for coupling.

Another feature provides a method for forming a barrier to an opening that comprises securing a support member to a first support surface above an opening, the support member comprising a plurality of mount holes spaced along a length of the support member, removeably coupling a plurality of strip mounts to the plurality of mount holes, positioning a length of the plurality of strip mounts at an angle relative to the length of the support member, and coupling a plurality of strips to the plurality of strip mounts, wherein an end of each strip removeably couples to an independent strip mount. In one embodiment, a first strip of the plurality of strips is coupled to a first strip mount of the plurality of strip mounts, and a second strip of the plurality of strips is coupled to a second strip mount of the plurality of strip mounts, the first strip mount positioned adjacent to the second strip mount, and the method further comprises adjusting a spacing between the first strip mount and the second strip mount to adjust an overlap of the first strip and the second strip. The method may further comprise positioning the length of the plurality of strip mounts at alternating angles relative to each other.

Another feature provides a strip door for forming a barrier to an opening that comprises a means for securing a support member to a first support surface above an opening, the support member comprising a plurality of mount holes spaced along a length of the support member, a means for removeably coupling a plurality of strip mounts to the plurality of mount holes, a means for positioning a length of the plurality of strip mounts at an angle relative to the length of the support member, and a means for coupling a plurality of strips to the plurality of strip mounts, wherein an end of each strip removeably couples to an independent strip mount.

Another feature provides a strip door kit that comprises a plurality of strip door components packaged together in an at least partially unassembled state for sale to consumers, wherein the strip door components comprise: a bracket adapted to secure to a first support surface associated with an opening, the bracket comprising a plurality of mount holes spaced along a length of the bracket; a plurality of strip mounts wherein each strip mount is adapted to couple to at least one of the plurality of mount holes, the plurality of strip mounts adapted to be arranged along the length of the bracket; and a plurality of strips adapted to hang in a partially overlapping arrangement to form a barrier to the opening, each strip comprising a first end and a second end, wherein the first end of each strip is adapted to removeably couple to an independent strip mount of the plurality of strip mounts.

### BRIEF DESCRIPTION OF THE DRAWINGS

The features, nature, and advantages of the present features may become more apparent from the detailed description set forth below when taken in conjunction with the drawings in which like reference characters identify correspondingly throughout.

FIG. 1 illustrates a plastic strip door found in the prior art.

FIG. 2 illustrates a front view of a strip door.

FIG. 3A illustrates a perspective view of a portion a strip door.

FIG. 3B illustrates a side view of a portion of a strip door.

FIG. 4 illustrates a perspective view of a strip.

FIG. 5 illustrates a perspective view of a portion of a strip.

FIG. 6 illustrates a perspective view of a strip mount.

FIG. 7 illustrates a front view of a portion of a strip door.

FIG. 8 illustrates a side view of a portion of a strip door.

FIG. 9 illustrates a perspective view of a bracket.

FIG. 10 illustrates a side view of a bracket.

FIG. 11 illustrates a top view of a bracket.

FIG. 12 illustrates a bottom view of a portion of a bracket.

FIG. 13 illustrates a bottom view of a strip door.

FIG. 14 illustrates two strip mounts coupled to a portion of a bracket.

FIG. 15 illustrates two strip mounts coupled to a portion of a bracket.

FIG. 16 illustrates various brackets having different lengths.

FIG. 17 illustrates a front view of a portion of a bracket and a sealing strip.

FIG. 18 illustrates a side view of a bracket and a sealing strip.

FIGS. 19 and 20 illustrate loop strips that may be used to secure a first end of a strip to a strip mount.

FIG. 21 illustrates a front view of a portion of a strip door.

FIG. 22 illustrates a strip door kit that contains one or more strip door components in a packaging for sale to a consumer in an, at least partially, unassembled state.

FIG. 23 illustrates strip door components that may be included in a strip door kit.

FIG. 24 illustrates a flowchart for forming a barrier at a doorway or an opening, such as an opening in a wall or truck container.

### DETAILED DESCRIPTION

In the following description numerous specific details are set forth in order to provide a thorough understanding of the disclosure. However, one skilled in the art would recognize that the invention might be practiced without these specific details. In other instances, well known methods, procedures, and/or components have not been described in detail so as not to unnecessarily obscure aspects of the disclosure.

### Strip Door

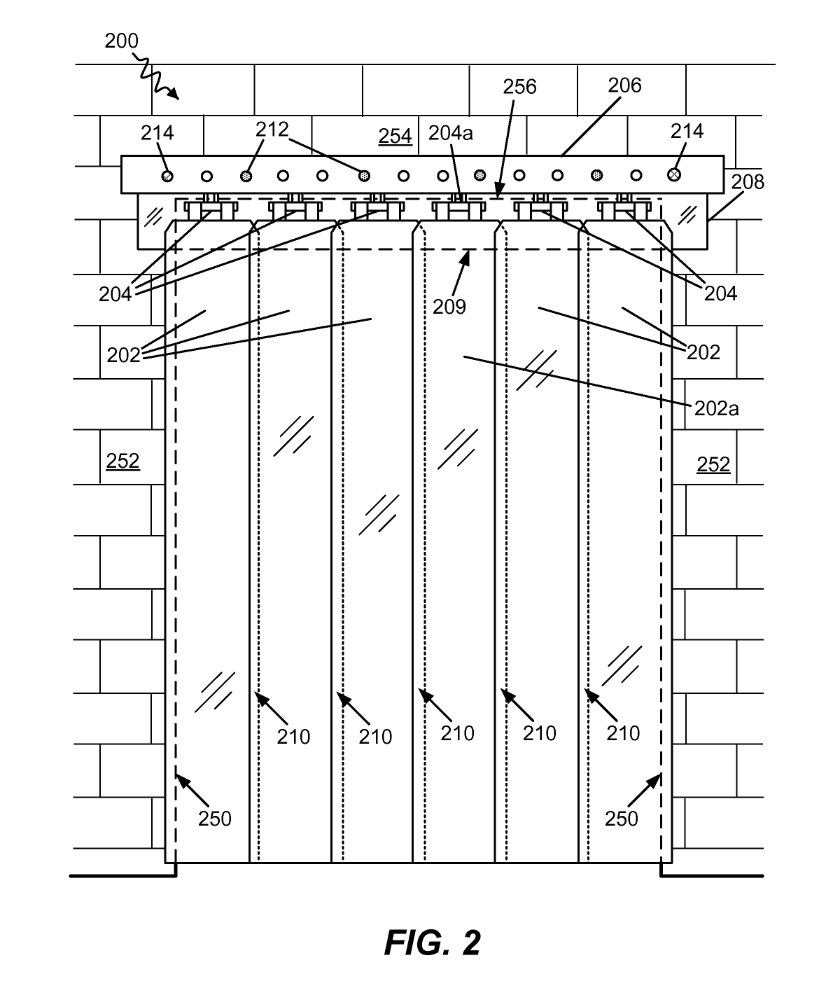

FIG. 2 illustrates a front view of a strip door 200 according to one embodiment. In the illustrated example, the strip door 200 provides an insulting, thermal barrier for an opening 250. The strip door 200 may comprise a plurality of strips 202, 202a, a plurality of strip mounts 204, 204a, a bracket (also referred to herein as a “support member”) 206, and a sealing strip 208.

The plurality of strips 202, 202a hang vertically in a partially overlapping 210 arrangement to form a barrier to the opening 250. Each of the strips 202, 202a are removeably coupled to a separate and independent strip mount 204, 204a. For example, a strip 202a is uniquely and independently coupled to an associated strip mount 204a. Besides serving as a support for the strips 202, 202a, the strip mounts 204, 204a are each coupled to the bracket 206. In turn, the bracket 206 is secured to a first support surface 254 associated with the opening 250 via one or more fasteners 212. In the illustrated example, the first support surface 254, is a portion of a wall 252 above the wall opening 250. The sealing strip 208 helps further insulate the opening 250 by forming an additional barrier near the top edge 256 of the opening 250 (i.e., just below the first support surface 254), such that an end 209 of the sealing strip 208 extends below the top edge 256 of the opening 250. The length of the sealing strip 208 extends in a horizontal orientation that is substantially perpendicular to the vertical orientation of the length of the strips 202, 202a. In one embodiment, the sealing strip 208 may be secured in between the first support surface 254 and the bracket 206 via one or more fasteners 214.

A person desiring to pass through the strip door 200 may simply push/force open one or more of the strips 202, 202a to create a temporary part/space between one or more the strips 202, 202a. After the person passes through the part created between the strips 202, 202a, the strips 202, 202a will quickly return to their normal vertically hanging position. Thus, the strip door 200 may only momentarily be open so that heat transfer through the opening 250 is minimized. In the illustrated example, the opening 250 is an opening in a wall 252. However, the strip door 200 may serve as an insulating, thermal barrier for a variety of other openings including, but not limited to, an opening to a cargo container of a truck, an opening to a refrigerator/freezer and/or refrigerated room, and/or any other thermally insulated (hot or cold) compartment through which goods or people may pass through.

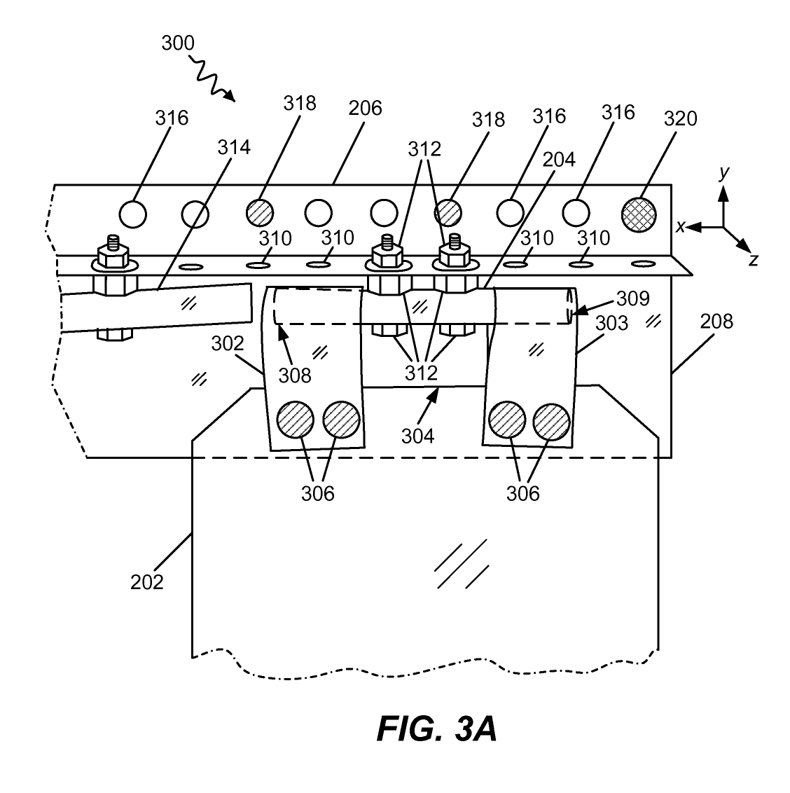

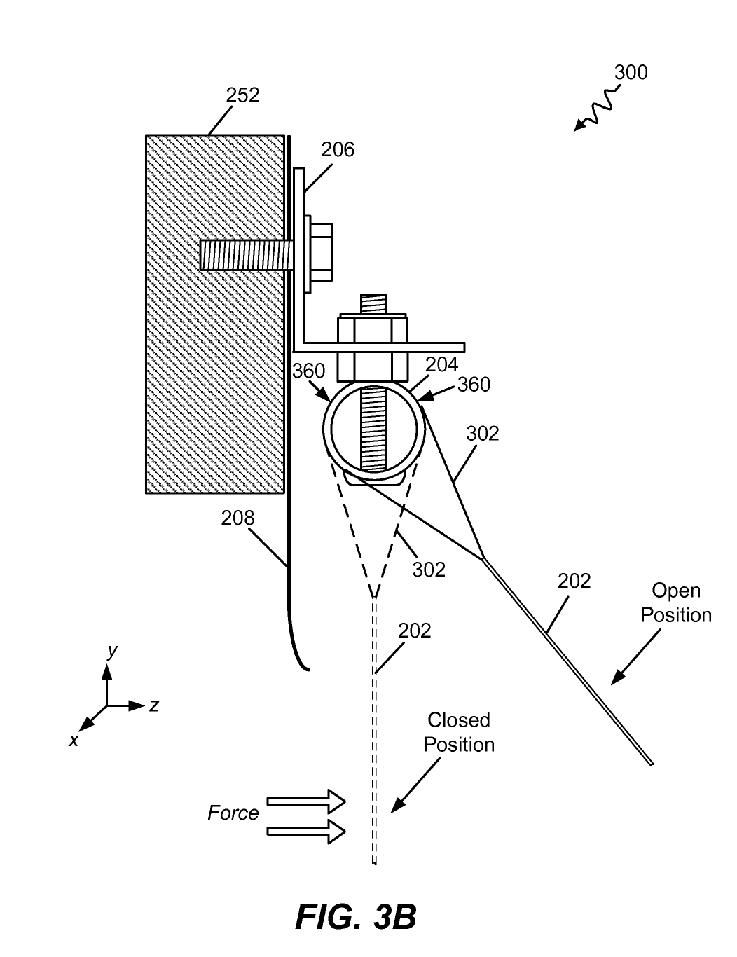

FIGS. 3A and 3B illustrate a perspective view and a side view, respectively, of a portion 300 of the strip door 200 according to one embodiment. Each strip 202 may comprise a first loop 302 (also referred to herein as a “first loop strip”) and a second loop 303 (also referred to herein as a “second loop strip”) that are each coupled to a first end 304 of the strip 202 via one or more loop fasteners 306. The first loop 302 removeably couples (e.g., slides onto) to a first end 308 of a strip mount 204, and the second loop 303 removeably couples (e.g., slides onto) to a second end 309 of the strip mount 204. Since the loops 302, 303 removeably couple to the ends 308, 309 of the strip mount 204, the strip 202 may be independently and quickly removed from the strip mount 204 and replaced with another strip in the event that the strip 202 is damaged or worn.

In the illustrated example, the first and second ends 308, 309 of the strip mount 204 comprise a curved surface that may be smooth and/or substantially non-stick. The curved surfaces of the first and second ends 308, 309 allow the first and second loops 302, 303 to freely rotate about the first and second ends 308, 309 when a force is applied, at least partially, along the z axis to the hanging strip 202 (e.g., when a person attempts to pass through the strip door 200 by pushing the strip 202). As illustrated in FIG. 3B, a force along the z axis (e.g., consistent with the direction of the double arrows) applied to the strip 202 that is initially in a “closed position” (indicated by the dashed outline) causes the loop strips 302, 303 to rotate about the curved surface 360 of the strip mount 204 moving the strip 202 to an “open position” (indicated by the solid lines).

Each strip mount 204 may be individually and independently coupled to one or more mount holes 310 of the bracket 206 via one or more mount fasteners 312. The mount holes 310 may be spaced apart at regular or irregular intervals along the length of the bracket 206. The mount fasteners 312 allow the strip mount 204 to be removeably coupled to various mount holes 310 along the length of the bracket 206. Thus, the strip mount 204 may be disconnected from one mount hole 310 and fastened to another mount hole 310 in order to adjust a spacing between the strip mount 204 and an adjacent strip mount 314. The spacing between the strip mount 204 and the adjacent strip mount 314 determines the amount of strip overlap associated with the strip 202 and an adjacent strip (not shown in FIG. 3 for clarity) that is coupled to the adjacent strip mount 314.

The bracket 206 may also comprise a plurality of support holes 316. The support holes 316 allow the bracket 206 to be secured to a first support surface 254 (See FIG. 2) via one or more bracket fasteners 318 (See FIG. 3). In one embodiment, the bracket fasteners 318 secure the bracket 206 to the first support surface 254 at regular or irregular intervals equal to or greater than one (1) inch. The sealing strip 208 may be coupled to the bracket 206 via one or more sealing strip fasteners 320 (e.g., snap rivets) that secure the sealing strip 208 to one or more of the support holes 320. The loop fasteners 306, mount fasteners 312, bracket fasteners 316, and sealing strip fasteners 320 may include, but are not limited to, bolts, nuts, washers, screws, snap rivets, etc., and may be composed of a variety materials including, but not limited to, plastic, wood, metal, etc.

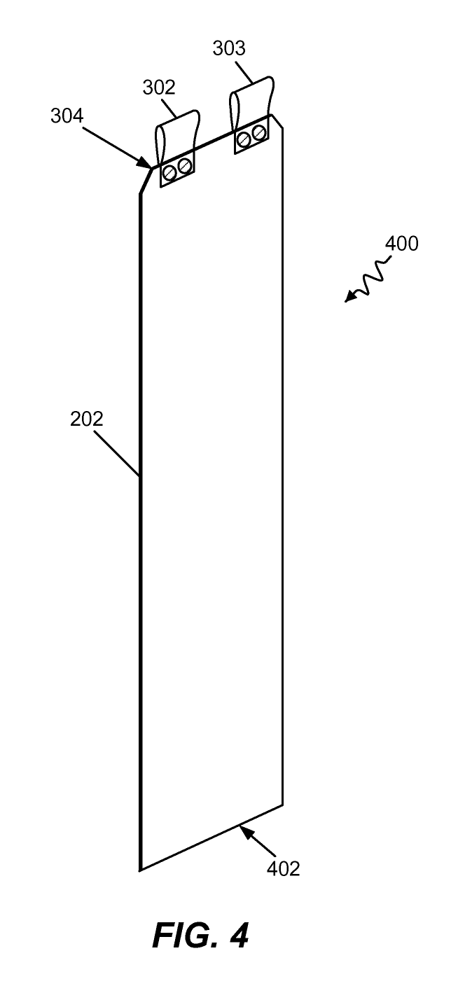

FIG. 4 illustrates a perspective view of the strip 202 according to one embodiment. The strip 202 comprises the first end 304 and a second end 402. As discussed above, the strip 202 includes the first loop 302 and the second loop 303 that are each coupled at or proximate to the first end 304 of the strip 202. The second end 402 of the strip 202 may hang close to (e.g., ¼ inch from) or even touch the floor of the opening 250 in which it hangs. The strip 202 may be composed of any flexible material such as, but not limited to, plastic, nylon, vinyl, etc. In some embodiments, the strip 202 is transparent or translucent so that a person can pass through the strip door 200 with confidence by being able to see whether there is an obstruction on the other side.

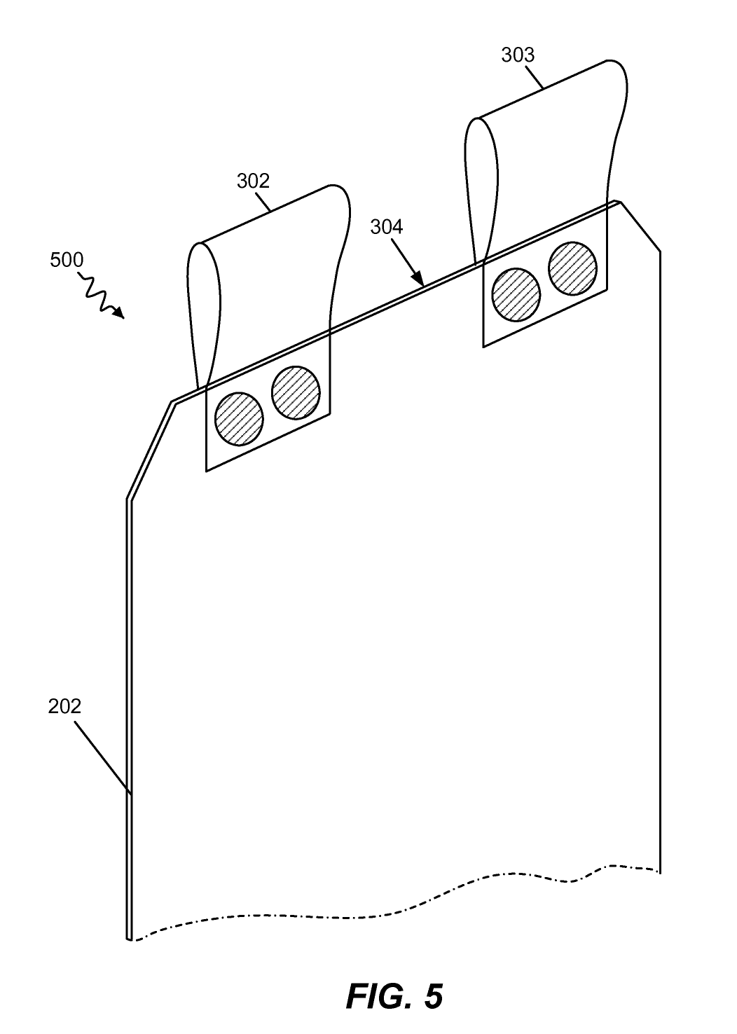

FIG. 5 illustrates a perspective view of a portion 500 of the strip 202 according to one embodiment. As described above, the strip 202 may include the first loop 302 and the second loop 303 that are each coupled to the first end 304 of the strip 202 via one or more loop fasteners 306.

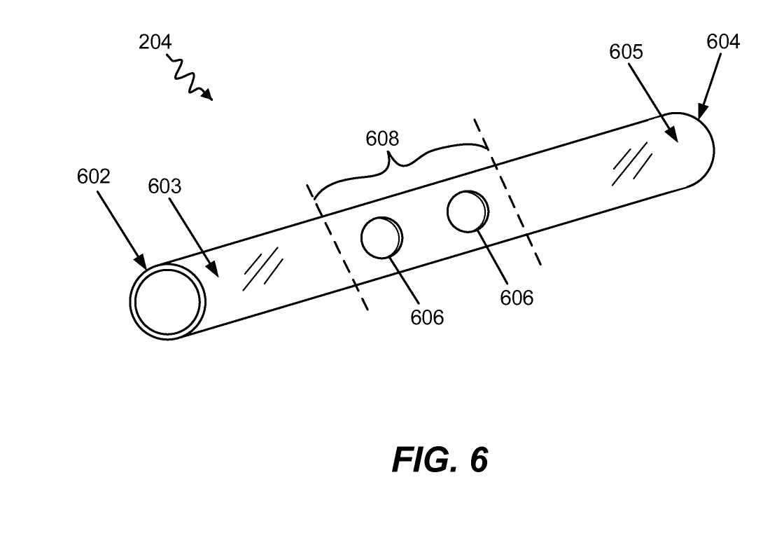

FIG. 6 illustrates a perspective view of the strip mount 204 according to one embodiment. The strip mount 204 may comprise a first end 602, a second end 604, and one or more holes 606. The first end 602 may include a first curved surface 603 that allows the first loop 302 (See FIG. 3) to removeably couple to the first end 602 of the strip mount 204. The second end 604 may also include a second curved surface 605 that allows the second loop 303 (See FIG. 3) to removeably couple to the second end 604 of the strip mount 204. In the illustrated example, the strip mount 204 is an elongate, hollow, cylindrical rod. However, in other embodiments, the first curved surface 603 and the second curved surface 605 may be distinct and separated from one another by central portion 608 of the strip mount 204 that may have a different cross-section (e.g., triangular, square, rectangular, or other polygonal cross-section) than the cross-sections of the first and second ends 602, 604 of the strip mount 204. In some embodiments, the cross-section of the first and second ends 602, 604 of the strip mount 204 may be oval, elliptical, or a partially curved polygon. In another embodiment, the first and second ends 602, 604 of the strip mount 204 may be flared to help prevent the loops 302, 303 from sliding off of the ends 602, 604.

The holes 606 are adapted to receive one or more mount fasteners 312 that serve to couple the strip mount 204 to the bracket 206 (See FIG. 3). Referring to FIG. 6, in one embodiment, the central portion 608 includes the holes 606. The strip mount 204 may be composed of any rigid material such as, but not limited to, plastic, wood, ceramic, and/or metal (e.g., aluminum, titanium, or a metal alloy such as steel).

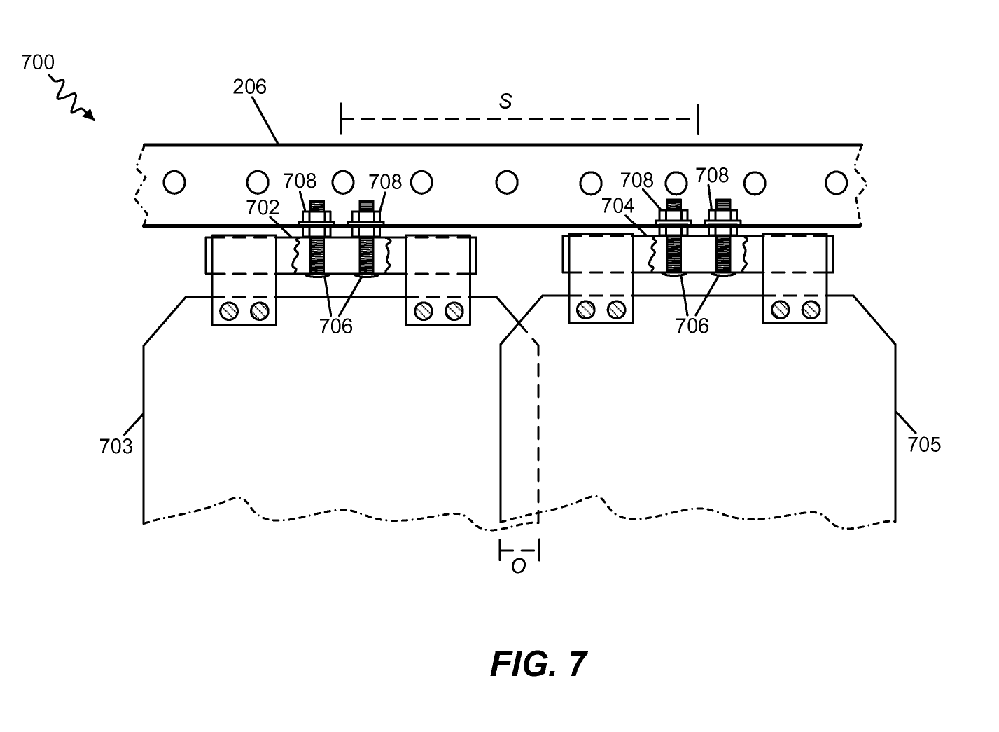

FIG. 7 illustrates a front view of a portion 700 of the strip door 200 according to one embodiment. In the illustrated example, two (2) strip mounts 702, 704 are positioned adjacent to one another along the length of the bracket 206, and each strip mount has a separate, independent strip 703, 705 removeably coupled to it. The strip mounts 702, 704 are secured to one or more mount holes 310 (See FIG. 3) via one or more mount fasteners 706, 708. A portion of the strip mounts 702, 704 has been removed to illustrate how the mount fasteners (e.g., bolts and/or screws) 706 may pass through the strip mounts 702, 704 to help secure the mounts 702, 704 to the bracket 206. The strip mounts 702, 704 are removeably coupled to the bracket 206 and may be repositioned along the length of the bracket 206 thereby adjusting a strip mount spacing S between the strip mounts 702, 704. A user may adjust the strip mount spacing S in order to achieve the desired strip overlap O between adjacent strips 703, 705.

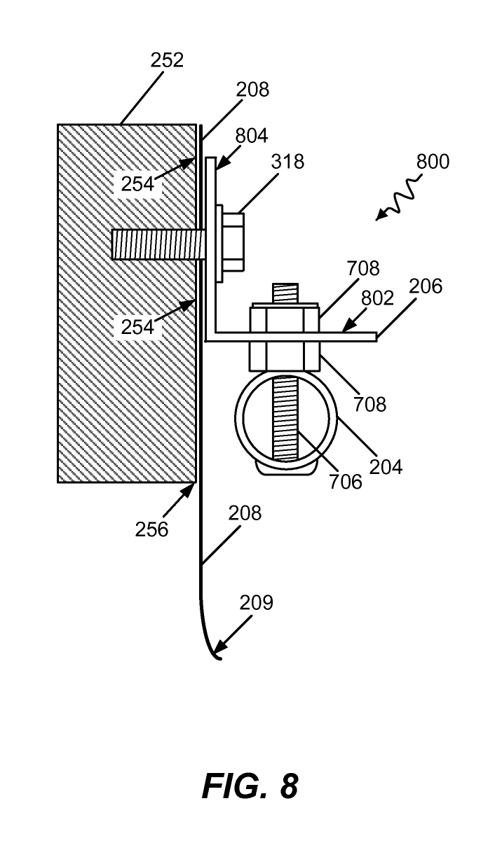

FIG. 8 illustrates a side view of a portion 800 of the strip door 200 according to one embodiment. The strip mount 204 may be secured to a first portion 802 of the bracket 206 via one or more mount fasteners 706, 708. As illustrated, the strip mount 204 may be hollow. The bracket 206 and the sealing strip 208 are secured against the first support surface 254 of the wall 252 via one or more bracket fasteners 318. In the example shown, the sealing strip 208 is positioned in between a second portion 804 of the bracket 206 and the first support surface 254. In other embodiments, the sealing strip 208 may be secured and positioned in between the bracket 206 and one or more of the strip mounts 204. The end 209 of the sealing strip 208 may hang down below (i.e., extend beyond) the top edge 256 of the opening 250.

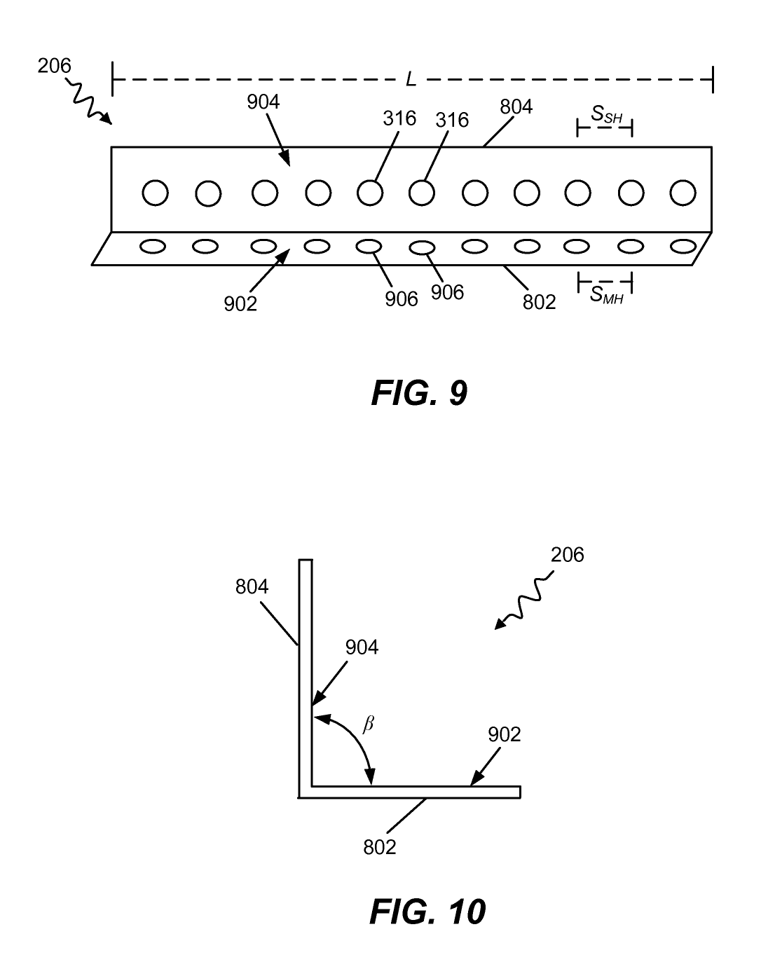

FIG. 9 illustrates a perspective view of a bracket 206 according to one embodiment. The bracket 206 comprises the first portion 802 having a first surface 902, and the second portion 804 having a second surface 904. The first surface 902 includes a plurality of mount holes 906 spaced at regular or irregular intervals along a length L of the bracket 206. The second surface 904 includes the plurality of support holes 316 spaced at regular or irregular intervals along the length L of the bracket 206. In one embodiment, the spacing S_{SH} between the support holes 316 may be equal to or greater than 0.125 inch. In one embodiment, the spacing S_{MH} between the mount holes 906 may be equal to or greater than 0.125 inch. The bracket 206 may be composed of any rigid material such as, but not limited to, metal (e.g., aluminum, titanium, or an alloy such as steel), plastic, ceramic, and/or wood.

FIG. 10 illustrates a side view of the bracket 206 according to one embodiment. The first portion 802 may be positioned at an angle β relative to the second portion 804 of the bracket 206. Thus, the first surface 902 may also be positioned at an angle β relative to the second surface 904 of the bracket 206. In the illustrated example, the angle β is approximately ninety (90) degrees such that the first portion 802 and the first surface 902 are substantially perpendicular to the second portion 804 and the second surface 904, respectively. In other embodiments, the angle β may be any value between zero (0) and one hundred eighty (180) degrees. In some embodiments, the angle β may be any value between sixty (60) and one hundred twenty (120) degrees. In embodiments where the angle β is zero (0) degrees, the first portion 802 and the first surface 902 may be absent, and the support holes 316 may double as mount holes 906 (i.e., the strip mounts 204 may be coupled to the support holes 316 via fasteners).

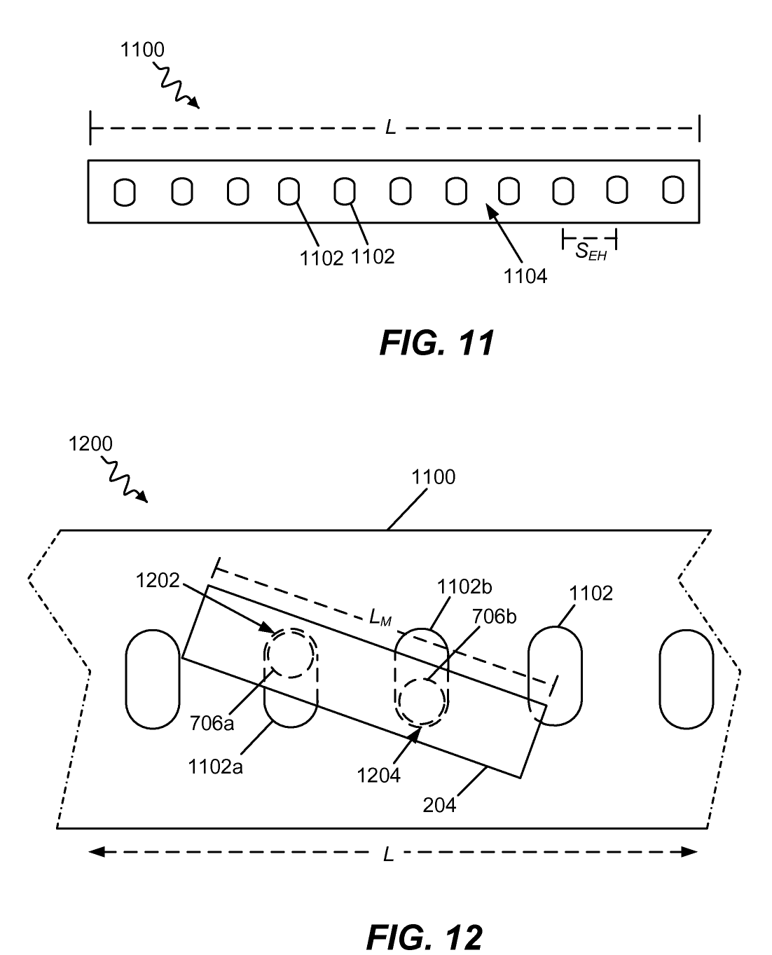

FIG. 11 illustrates a top view of a bracket 1100 according to one embodiment. The bracket 1100 may be identical to the bracket 206 of FIG. 9 except that the mount holes 1102 on the first surface 1104 of the bracket 1100 shown in FIG. 11 are elongated holes. The elongated mount holes 1102 are spaced at regular or irregular intervals along a length L of the bracket 1100. In one embodiment, the spacing S_{EH} between the elongated mount holes 1102 may be equal to or greater than 0.125 inch.

FIG. 12 illustrates a bottom view of a portion 1200 of the bracket 1100 according to one embodiment. The elongated mount holes 1102, 1102a, 1102b provide a means for the length L_{M} of strip mounts 204 to be positioned at an angle relative to the length L of the bracket 1100. For example, a mount fastener 706a may couple one portion of the strip mount 204 to the top end 1202 of an elongated mount hole 1102a. Similarly, another mount fastener 706b may couple another portion of the strip mount 204 to the bottom end 1204 of an adjacent elongated mount hole 1102b. By adjusting the positions at which the fasteners 706a and/or 706b secure the strip mount 204 to the elongated mount holes 1102a and/or 1102b, a user can adjust the angle of the length L_{M} of the strip mount 204 with respect to the length L of the bracket 1100. In this fashion, the length L_{M} of the strip mount 204 may be positioned at an angle greater than zero (0) relative to the length of the bracket 1100 (i.e., at an angle where the length L_{M} of the strip mount 204 is not parallel to the length L of the bracket 1100).

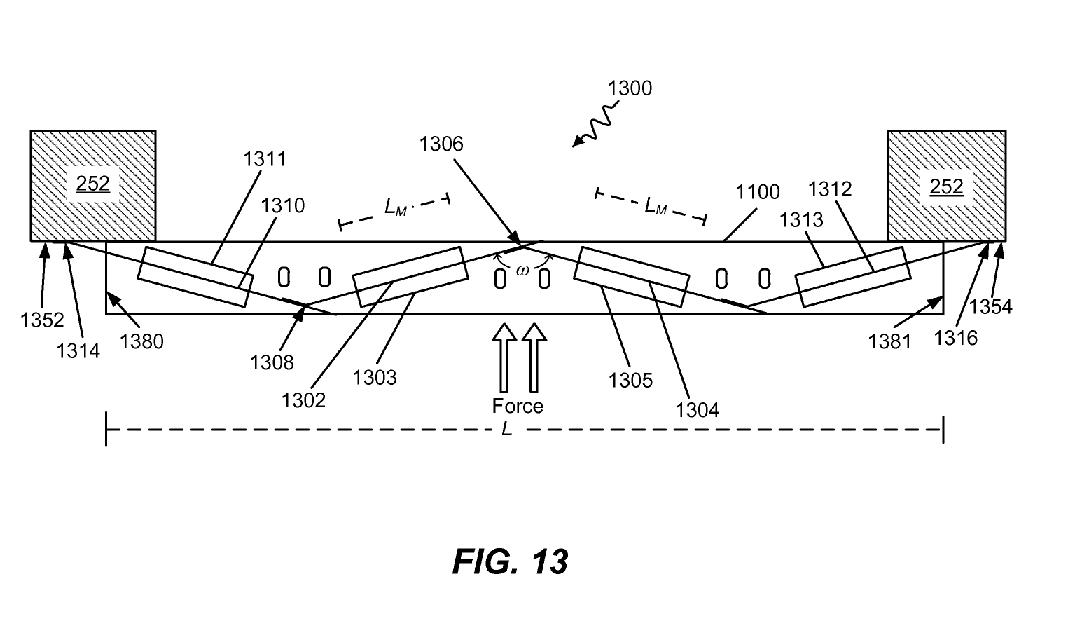

FIG. 13 illustrates a bottom view of a strip door 1300 according to one embodiment. Each end 1380, 1381 of the strip door's bracket 1100 is secured to the wall 252. The strip mounts 1303, 1305, 1311, 1313 are removeably coupled to the bracket 1100 such that the lengths L_{M} of the strip mounts 1303, 1305, 1311, 1313 are at alternating angles with respect to each another. The lengths L_{M} of the strip mounts 1303, 1305, 1311, 1313 may be positioned at angles relative to the length L of the bracket 1100 by utilizing the elongated mount holes 1102, 1102a, 1102b shown in at least FIG. 12. Referring to FIG. 13, the strips 1302, 1304, 1310, 1312 are also arranged at alternating angles with respect to each other since the strips 1302, 1304, 1310, 1312 are coupled to the strip mounts 1303, 1305, 1311, 1313. This causes the strips 1302, 1304, 1310, 1312 to overlap with one another at an angle as well.

For example, the strip 1302 coupled to the strip mount 1303 overlaps with the adjacent strip 1304 that is coupled to the strip mount 1305. The point 1306 where the two strips 1302, 1304 overlap has an overlap angle ω associated with it that is less than 180 degrees. This allows the two strips 1302, 1304 to part more easily (i.e., with less force) when a person/cargo passing through the strip door 1300 in the direction indicated by the double arrows pushes against one or both of the strips 1302, 1304. That is, when a force is applied to the strips 1302, 1304 in a direction consistent with the double arrows shown in FIG. 13, the strips 1302, 1304 part with more ease (compared to conventional strip doors) to allow for easier passage through the strip door 1300. Similarly, a person/cargo desiring to traverse through the strip door 1300 in a direction opposite to that indicated by the double arrows may apply a force to one or both of the strips 1310, 1302 to cause the angled overlap 1308 to part with ease.

Moreover, a first strip 1310 coupled to a first strip mount 1311 may be positioned at an angle with respect to the length L of the bracket 1100 such that a first edge 1314 of the first strip 1310 makes contact with (or comes very close to) a second support surface 1352 associated with the wall 252. Similarly, a second strip 1312 coupled to a second strip mount 1313 may be positioned at an angle with respect to the length L of the bracket 1100 such that a first edge 1316 of the second strip 1312 makes contact with (or comes very close to) a third support surface 1354 associated with the wall 252.

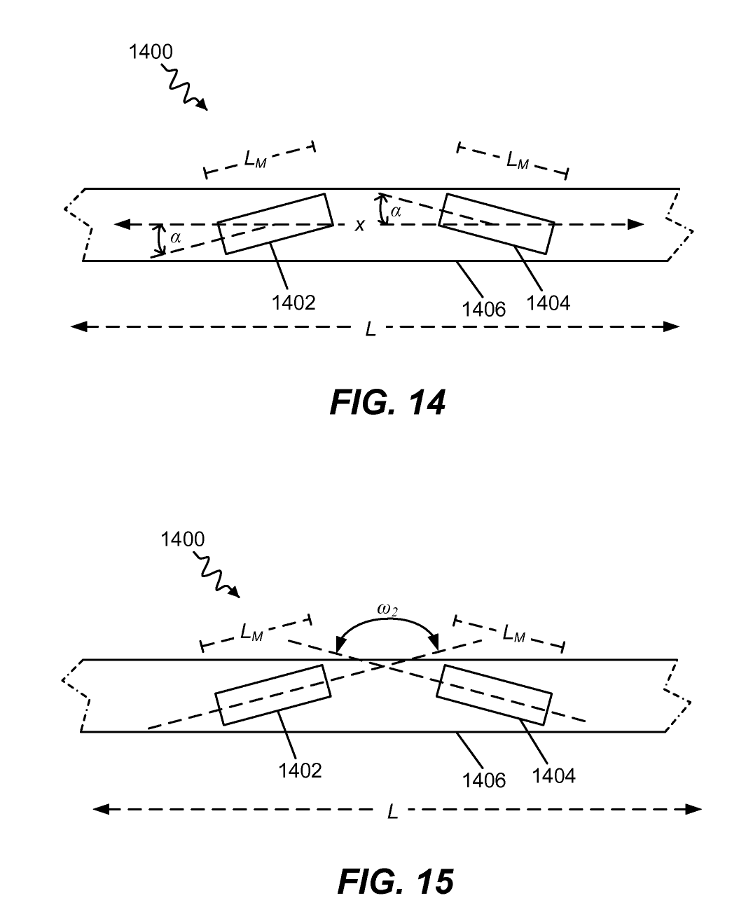

FIG. 14 illustrates two strip mounts 1402, 1404 coupled to a portion 1400 of a bracket 1406 according to one embodiment. The lengths L_{M} of the strip mounts 1402, 1404 are positioned at an angle α with respect to an axis x that is parallel to the length L of the bracket 1406. The angle α is adjustable by varying the positioning of the fasteners that couple the strip mounts 1402, 1404 to the mount holes of the bracket 1406 (See, for example, FIG. 12). For example, in one embodiment, the angle α may be adjustable between zero (0) and sixty (60) degrees. In one embodiment, the angle α is equal to about twenty (20) degrees.

FIG. 15 illustrates two strip mounts 1402, 1404 coupled to a portion 1400 of a bracket 1406 according to one embodiment. The lengths L_{M} of the strip mounts 1402, 1404 are positioned at an angle ω₂ with respect to each other. The angle ω₂ is adjustable by varying the positioning of the fasteners that couple the strip mounts 1402, 1404 to the mount holes of the bracket 1406 (See for example FIG. 12). For example, in one embodiment, the angle ω₂ may be adjustable between sixty (60) and one hundred eighty (180) degrees. In one embodiment, the angle ω₂ is equal to about one hundred forty (140) degrees.

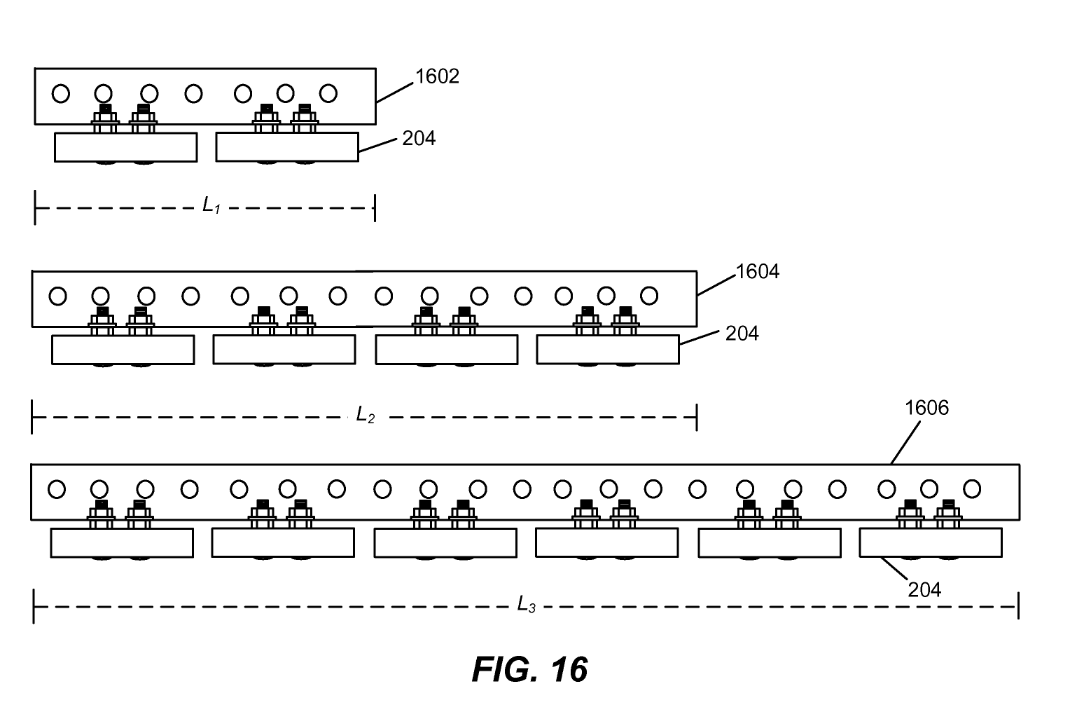

FIG. 16 illustrates various brackets 1602, 1604, 1606 having different lengths L₁, L₂, L₃ according to one embodiment. Each bracket 1602, 1604, 1606 may accommodate a different number of strip mounts 204 depending on the length of the bracket 1602, 1604, 1606. Moreover, multiple brackets 1602, 1604, 1606 may be secured side by side to accommodate openings of various widths. For example, the brackets 1602, 1604, 1606 may be available in lengths L₁, L₂, L₃ equal to six (6), twelve (12), eighteen (18), twenty-four (24), thirty (30), thirty-six (36), forty-two (42), forty-eight (48), fifty-four (54), and/or sixty (60) inches. They may be secured side by side to one another onto the first secure surface 254 in a multitude of permutations to accommodate a variety of doorway openings.

For example, a thirty-six (36) inch bracket may be used to accommodate an opening having a thirty-eight (38) inch width. A thirty-six (36) inch bracket secured side by side to a twelve (12) inch bracket may be used to accommodate an opening having a fifty (50) inch width. A thirty-six (36) inch bracket secured side by side to a twenty-four (24) inch bracket may be used to accommodate an opening having a sixty-two (62) inch width. A thirty-six (36) inch bracket secured side by side to another thirty-six (36) inch bracket may be used to accommodate an opening having a seventy-two (72) inch width. As another example, three (3) brackets (two (2) thirty-six (36) inch brackets and one (1) twelve (12) inch bracket) may be secured side by side to accommodate an opening having an eighty-four (84) inch width. Three (3) brackets (two (2) thirty-six (36) inch brackets and one (1) twenty-four (24) inch bracket) may also be secured side by side to accommodate an opening having a ninety-six (96) inch width. In other embodiments, brackets having a length longer than the width of the opening may be secured to the first support surface 254. For example, a thirty-six (36) inch bracket may be secured side by side to a twenty-four (24) inch bracket to accommodate an opening having a fifty-four (54) inch width, etc.

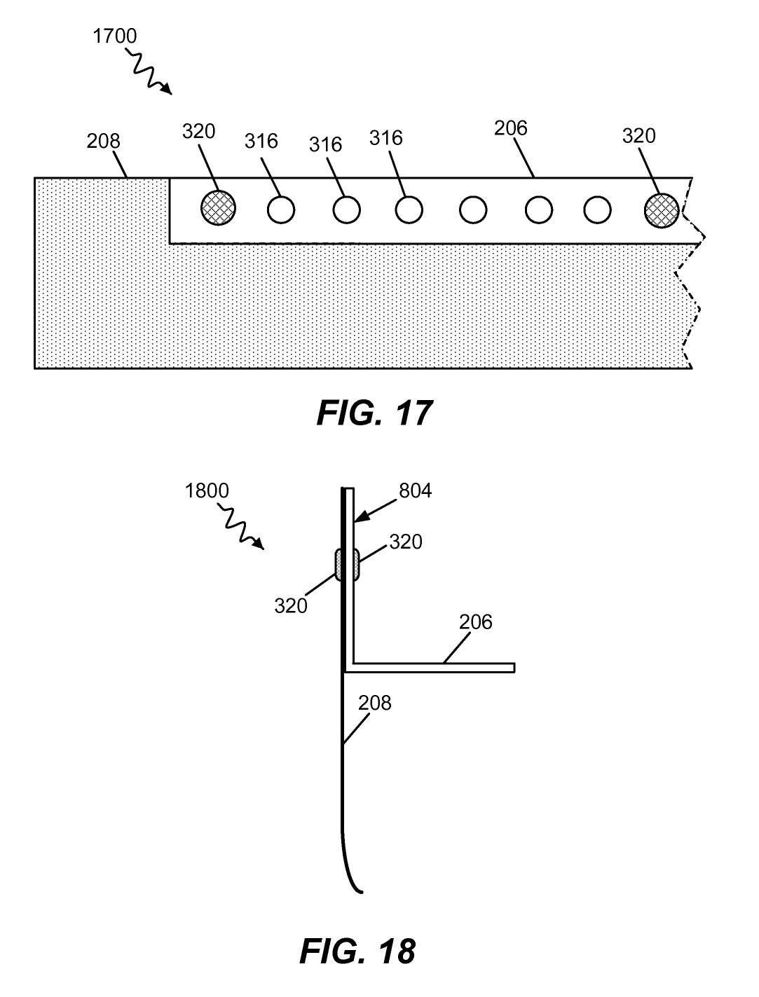

FIG. 17 illustrates a front view of a portion 1700 of the bracket 206 and the sealing strip 208 according to one embodiment. The sealing strip 208 is secured to the bracket 206 via one or more sealing strip fasteners (e.g., snap rivets) 320 that couple to any one of the plurality of support holes 316. The sealing strip 208 may be composed of any flexible material such as, but not limited to, plastic, nylon, vinyl, etc., and may be transparent or translucent. FIG. 18 illustrates a side view 1800 of the bracket 206 and the sealing strip 208 according to one embodiment. The sealing strip 208 may be secured to the second portion 804 of the bracket 206 via one or more sealing strip fasteners 320.

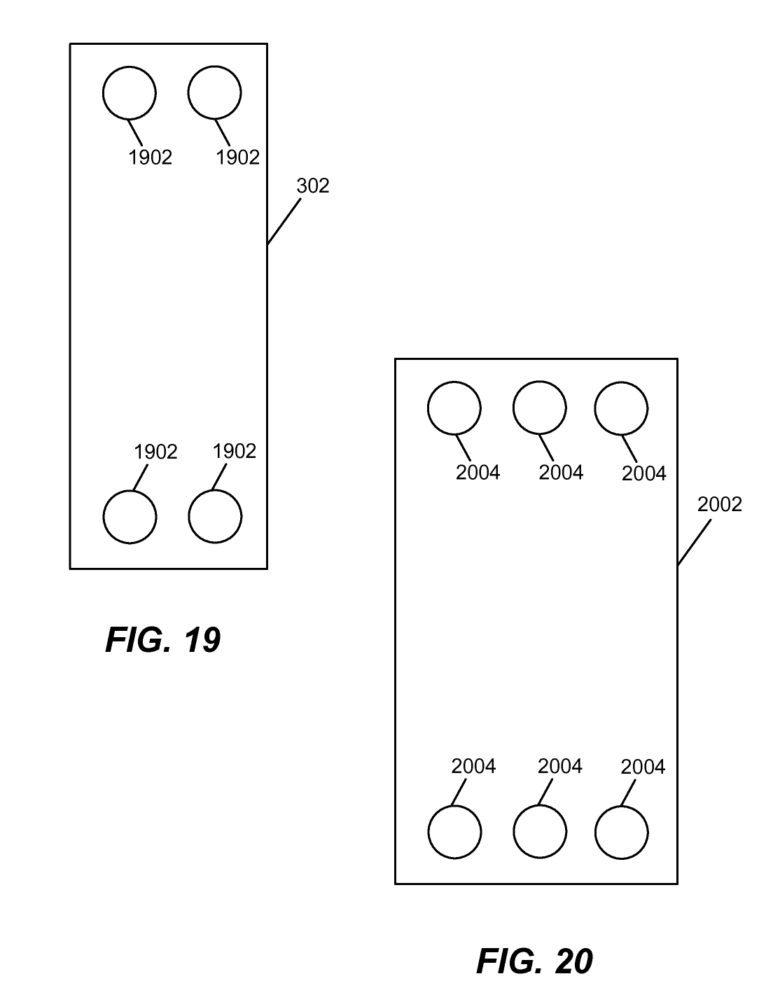

FIG. 19 illustrates the loop strip 302 that is used to secure the first end 304 of the strip 202 to the strip mount 204 (See for example FIG. 3) according to one embodiment. Referring to FIG. 19, the loop strip 302 is shown in an unfolded state, and comprises a plurality of loop holes 1902 that may be used to secure the loop strip 302 to the strip's first end 304 in a folded state using one or more loop fasteners 306 (See FIG. 3). In the example illustrated in FIG. 19, the loop strip 302 features four (4) loop holes 1902.

FIG. 20 illustrates another loop strip 2002 that may be used to secure the first end 304 of the strip 202 to the strip mount 204 (See for example FIG. 3) according to one embodiment. Referring to FIG. 20, the loop strip 2002 is an unfolded state, and comprises a plurality of holes 2004 that may be used to secure the loop strip 2002 to the strip's first end 304 in a folded state using one or more loop fasteners 306 (See FIG. 3). In the example illustrated in FIG. 20, the loop strip 2002 features six (6) loop holes 2004. The loop strips 302, 2002 may be composed of any flexible material such as, but not limited to, plastic, nylon, vinyl, etc., and may be transparent or translucent.

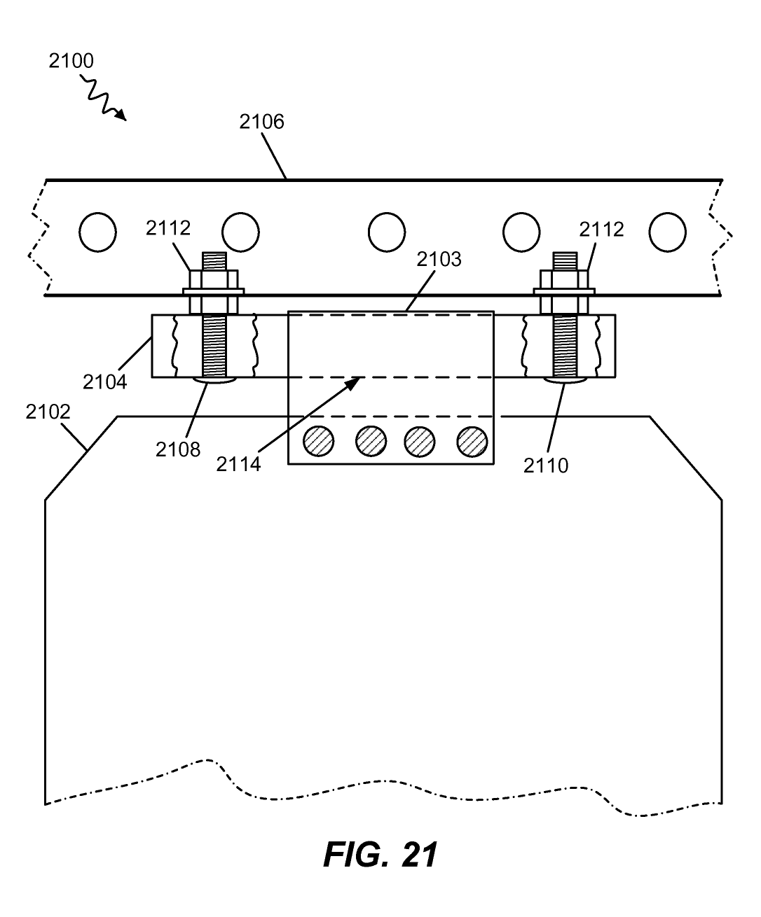

FIG. 21 illustrates a front view of a portion of a strip door 2100 according to one embodiment. In the illustrated example, a strip mount 2104 is removeably coupled to a bracket 2106. The strip mount 2104 also has a separate, independent strip 2102 that is removeably coupled to it. The strip mount 2104 is secured to one or more mount holes on the bracket 2106 via one or more mount fasteners 2108, 2110, 2112. Portions of the strip mount 2104 have been removed to illustrate how the mount fasteners (e.g., bolts and/or screws) 2108, 2110 pass through the strip mount 2104 to help secure the mount 2104 to the bracket 2106. In the illustrated example, the strip 2102 includes a single loop strip 2103 that is coupled to a central portion 2114 of the strip mount 2104 in between the first fastener 2108 and the second fastener 2110.

### Strip Door Kit

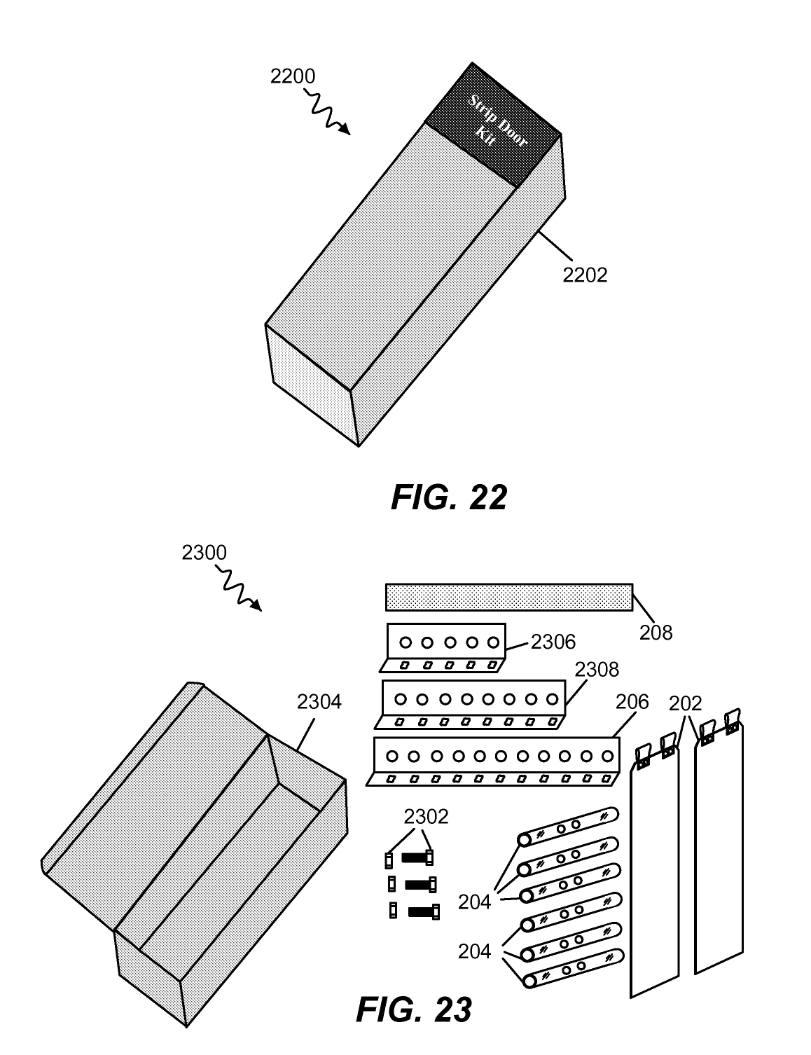

FIG. 22 illustrates a strip door kit 2200 that contains one or more strip door components in a packaging 2202 for sale to a consumer in an, at least partially, unassembled state. FIG. 23 illustrates, for example, some of the strip door components 2300 that may be included in the strip door kit 2200. The strip door components 2300 may comprise, in one embodiment, a plurality of strips 202, a plurality of strip mounts 204, at least one bracket 206, at least one sealing strip 208, a plurality of fasteners 2302 (including, for example, loop fasteners 306, mount fasteners 312, 706, 708, bracket fasteners 318, and/or sealing strip fasteners 320), and/or a carrying case 2304. In one embodiment, the strip door components 2300 may further comprise additional brackets 2306, 2308 having different lengths to accommodate openings of various widths.

The carrying case 2304 is configured to store the strip door components 2300, and may be a sturdy container with a handle, or a flexible bag such as a duffle bag. The carrying case 2304 allows for increased portability of the strip door since all the necessary components of the strip door may be included in the carrying case 2304 for ease of transportation from one opening to another.

### Method for Forming a Barrier to an Opening

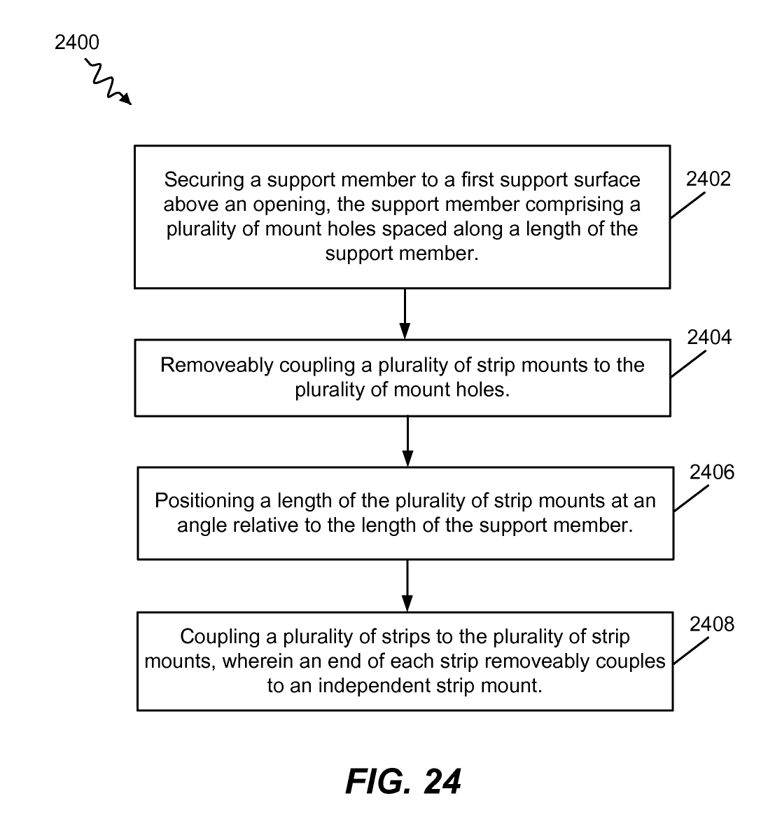

FIG. 24 illustrates a flowchart 2400 for forming a barrier at a doorway or an opening, such as an opening in a wall or truck container, according to one embodiment. First, at step 2402, a support member is secured to a first support surface above an opening, the support member comprising a plurality of mount holes spaced along a length of the support member. Next, at step 2404, a plurality of strip mounts are removeably coupled to the plurality of mount holes. Next, at step 2406, a length of the plurality of strip mounts are positioned at an angle relative to the length of the support member. Then, at step 2408, a plurality of strips are coupled to the plurality of strip mounts, wherein an end of each strip removeably couples to an independent strip mount.

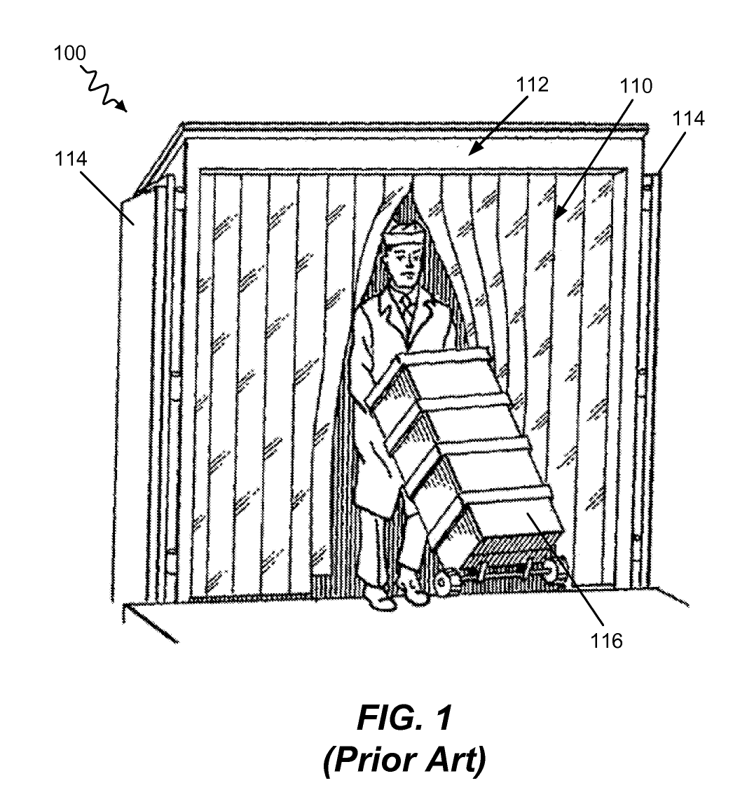

One or more of the components and functions illustrated in FIGS. 1-24 may be rearranged and/or combined into a single component or embodied in several components without departing from the invention. Additional elements or components may also be added without departing from the invention.

While certain exemplary embodiments have been described and shown in the accompanying drawings, it is to be understood that such embodiments are merely illustrative of and not restrictive of the broad disclosure, and that the present disclosure not be limited to the specific constructions and arrangements shown and described, since various other modifications are possible. Those skilled, in the art will appreciate that various adaptations and modifications of the just described embodiments can be configured without departing from the scope and spirit of the present disclosure. Therefore, it is to be understood that, within the scope of the appended claims, the present disclosure may be practiced other than as specifically described herein.

What is claimed is:

1. A strip door, comprising:
a bracket adapted to secure to a first support surface associated with an opening, the bracket comprising a plurality of mount holes spaced along a length of the bracket;
a plurality of strip mounts wherein each strip mount is adapted to couple to at least one of the plurality of mount holes, the plurality of strip mounts adapted to be arranged along the length of the bracket; and
a plurality of strips adapted to hang in a partially overlapping arrangement to form a barrier to the opening, each strip comprising a first end and a second end, wherein the first end of each strip is adapted to removeably couple to an independent strip mount of the plurality of strip mounts.

2. The strip door of claim 1, wherein the first end of each strip comprises:
a loop adapted to removably couple the strip to the independent strip mount.

3. The strip door of claim 1, wherein each strip mount comprises:
a first end;
a second end; and
at least one strip mount fastener positioned between the first end and the second end of the strip mount, the strip mount fastener adapted to removeably couple the strip mount to at least one of the mount holes of the bracket.

4. The strip door of claim 3, wherein the first end of each strip comprises:
a first loop; and
a second loop, wherein the first loop of the strip is adapted to removeably couple to the first end of the strip mount, and the second loop of the strip is adapted to removeably couple to the second end of the strip mount.

5. The strip door of claim 4, wherein the first end and the second end of the strip mount comprise a curved surface.

6. The strip door of claim 1, wherein each strip mount comprises:
a first strip mount fastener positioned at a first end of the strip mount, the first strip mount fastener adapted to removeably couple the first end of the strip mount to a first mount hole of the plurality of mount holes of the bracket; and
a second strip mount fastener positioned at a second end of the strip mount, the second strip mount fastener adapted to removeably couple the second end of the strip mount to a second mount hole of the plurality of mount holes of the bracket, wherein the first end of each strip comprises a loop adapted to removably couple to a region of the strip mount in between the first strip mount fastener and the second strip mount fastener of the strip mount.

7. The strip door of claim 1, further comprising:
a sealing strip adapted to secure, at least partially, between the first support surface and the bracket, wherein a length of the sealing strip is positioned parallel relative to the length of the bracket.

8. The strip door of claim 7, wherein the plurality of mount holes spaced along the length of the bracket are positioned on a first surface of the bracket, the bracket further comprising:
a second surface including a plurality of support holes, the second surface of the bracket positioned at an angle between sixty (60) and one hundred twenty (120) degrees relative to the first surface of the bracket, wherein the sealing strip is secured to at least one of the support holes via a sealing strip fastener.

9. The strip door of claim 1, wherein a length of each strip mount of the plurality of strip mounts is parallel to a length of an adjacent strip mount.

10. The strip door of claim 1, wherein a length of each strip mount of the plurality of strip mounts is positioned at an angle relative to a length of an adjacent strip mount.

11. The strip door of claim 1, wherein at least one strip mount of the plurality of strip mounts is positioned at an angle relative to the length of the bracket.

12. The strip door of claim 11, wherein the angle is between five (5) and thirty-five (35) degrees.

13. The strip door of claim 1, wherein the mount holes are elongated holes that are adapted to secure a length of each strip mount at an angle relative to the length of the bracket.

14. The strip door of claim 1, wherein the strip mounts are adapted to removeably couple to the mount holes to adjust a spacing between the strip mounts, the spacing between the strip mounts determining an amount of strip overlap of the plurality of strips.

15. The strip door of claim 1, wherein a first strip of the plurality of strips is coupled to a first strip mount of the plurality of strip mounts, and a length of the first strip mount is positioned at an angle relative to the length of the bracket such that a first edge of the first strip is adapted to contact a second support surface associated with the opening.

16. The strip door of claim 15, wherein a second strip of the plurality of strips is coupled to a second strip mount of the plurality of strip mounts, and a length of the second strip mount is positioned at an angle relative to the length of the bracket such that a first edge of the second strip is adapted to contact a third support surface associated with the opening.

17. A method for forming a barrier to an opening, the method comprising:
securing a support member to a first support surface above an opening, the support member comprising a plurality of mount holes spaced along a length of the support member;
removeably coupling a plurality of strip mounts to the plurality of mount holes;
positioning a length of the plurality of strip mounts at an angle relative to the length of the support member; and
coupling a plurality of strips to the plurality of strip mounts, wherein an end of each strip removeably couples to an independent strip mount.

18. The method of claim 17, wherein a first strip of the plurality of strips is coupled to a first strip mount of the plurality of strip mounts, and a second strip of the plurality of strips is coupled to a second strip mount of the plurality of strip mounts, the first strip mount positioned adjacent to the second strip mount, the method further comprising:
adjusting a spacing between the first strip mount and the second strip mount to adjust an overlap of the first strip and the second strip.

19. The method of claim 17, further comprising positioning the length of the plurality of strip mounts at alternating angles relative to each other.

20. A strip door kit, the kit comprising:
a plurality of strip door components packaged together in an at least partially unassembled state for sale to consumers, wherein the strip door components comprise:
a bracket adapted to secure to a first support surface associated with an opening, the bracket comprising a plurality of mount holes spaced along a length of the bracket;
a plurality of strip mounts wherein each strip mount is adapted to couple to at least one of the plurality of mount holes, the plurality of strip mounts adapted to be arranged along the length of the bracket; and
a plurality of strips adapted to hang in a partially overlapping arrangement to form a barrier to the opening, each strip comprising a first end and a second end, wherein the first end of each strip is adapted to removeably couple to an independent strip mount of the plurality of strip mounts.
